(19) United States
(12) Patent Application Publication
(10) Pub. No.: US 2026/0276894 A1
(43) Pub. Date: Sep. 17, 2026

(54) TWO-DIMENSIONAL FIBER COLLIMATOR ARRAY

(71) Applicant: Fuzhou Photop Optics Co., Ltd., Fuzhou (CN)

(72) Inventors: Xu Jia, Fuzhou (CN); Junjie Yao, Fuzhou (CN); Guanglong Yu, Fuzhou (CN); Junjie Chen, Fuzhou (CN); Yan Jiang, Fuzhou (CN); Xi Zheng, Fuzhou (CN); Lei Lin, Fuzhou (CN)

(21) Appl. No.: 19/097,626

(22) Filed: Apr. 1, 2025

(30) Foreign Application Priority Data
Mar. 12, 2025 (CN) 2025102930658

(51) Int. Cl. G02B 6/32

(52) U.S. Cl. CPC G02B 6/32

(57) ABSTRACT

A two-dimensional (2D) fiber collimator array may include a fiber hole plate, fibers, a grooved spacer, and a microlens array (MLA). Rows of holes may extend through the fiber hole plate from a fiber hole plate first side to a fiber hole plate second side. Each fiber may extend through a respective hole of the fiber hole plate and may include a fiber end face at the fiber hole plate second side. The grooved spacer may include a grooved spacer first side and a grooved spacer second side. The grooved spacer first side may include a plurality of microgrooves. Each microgroove may include an incident surface angled with respect to the grooved spacer first side. An adhesive may couple the grooved spacer first side to the fiber hole plate second side. A refractive index of the adhesive may substantially match a refractive index of the fiber end faces.

### CROSS REFERENCE TO RELATED APPLICATIONS

The present application claims benefit to and priority from Chinese Application Number 2025102930658, filed Mar. 12, 2025, the disclosure of which is hereby incorporated herein by reference in its entirety.

### TECHNICAL FIELD

Aspects of the present disclosure relate to optical communications and lasers, and in particular to two-dimensional (2D) fiber collimator arrays.

### BACKGROUND

Large-scale data centers may utilize optical circuit systems that include, among other things, two-dimensional (2D) fiber collimator arrays. Such two-dimensional (2D) fiber collimator arrays may arrange an M×N array of optical fibers (where M≥2, N≥2) in order to collimate light beams output from the fibers and produce an M×N array of collimating beams. Large-scale data center's pursuit of higher speeds, lower power consumption, and/or lower latency optical devices has increased performance requirements of two-dimensional (2D) fiber collimator arrays. In particular, single-fiber bidirectional communication designs may require a return loss (RL) of greater than 38 dB and typically greater than 42 dB in order to achieve a high signal-to-noise ratio. However, due to increases in optical signal transmission rates (e.g., from 50 Gbps/lane to 200 Gbps/lane), more stringent return loss (RL) requirements may be needed in order to improve signal-to-noise ratio and reduce bit error rates. In particular, existing two-dimensional (2D) fiber collimator arrays have gradually been unable to satisfy return loss (RL) requirements needed to obtain specified signal-to-noise ratios and bit error rates.

Further limitations and disadvantages of conventional and traditional approaches will become apparent to one of skill in the art, through comparison of such approaches with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are two-dimensional (2D) fiber collimator arrays and processes for manufacturing such two-dimensional (2D) fiber collimator arrays. In various embodiments, the two-dimensional (2D) fiber collimator array may exhibit improved operational characteristics. In particular, two-dimensional (2D) fiber collimator arrays per aspects of the present disclosure may exhibit better return loss (RL) characteristics (e.g., greater than 45 dB) compared to conventional two-dimensional (2D) fiber collimator arrays.

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIGS. 1A and 1B depict an embodiment of a two-dimensional (2D) fiber collimator array in accordance with various aspects of the present disclosure.

FIG. 2 provides a perspective view of a two-dimensional (2D) fiber array and a fiber hole plate of the two-dimensional (2D) fiber collimator array shown in FIGS. 1A and 1B.

FIG. 3A-3C provide various views and cross sections for a grooved spacer of the two-dimensional (2D) fiber collimator array shown in FIGS. 1A and 1B.

FIGS. 4A and 4B respectively depict V-grooves and U-grooves suitable for the grooved spacer of FIG. 3A-3C.

FIG. 5 depicts another example embodiment of a grooved spacer suitable for the two-dimensional (2D) fiber collimator array shown in FIGS. 1A and 1B.

FIG. 6 provides a perspective view of a microlens array (MLA) of the two-dimensional (2D) fiber collimator array shown in FIGS. 1A and 1B.

FIG. 7 depicts an optical path of a fiber through a respective portion of the grooved spacer and microlens array (MLA) of the two-dimensional (2D) fiber collimator array shown in FIGS. 1A and 1B.

FIG. 8 provides a graph depicting return loss (RL) versus wavelength for an implementation of the two-dimensional (2D) fiber collimator array of FIGS. 1A and 1B.

FIGS. 9A and 9B depict another embodiment of a two-dimensional (2D) fiber collimator array in accordance with various aspects of the present disclosure.

FIG. 10 provides a perspective view of a grooved microlens array (MLA) of the two-dimensional (2D) fiber collimator array shown in FIGS. 9A and 9B.

### DESCRIPTION

The following discussion provides various examples of two-dimensional (2D) fiber collimator arrays. The two-dimensional (2D) fiber collimator arrays may include a two-dimensional (2D) fiber array, a grooved spacer with microgrooves, and a microlens array (MLA). The two-dimensional (2D) fiber array may include an M×N array of single-mode (SM) fibers (where M≥2, N≥2) and a fiber hole plate. The fiber hole plate may include a corresponding M×N array of fiber holes. The fiber hole plate may arrange the fibers of the two-dimensional (2D) fiber array in the M×N array. An adhesive may affix the fibers in respective fiber holes of the fiber hole plate. A surface of the two-dimensional (2D) fiber array associated with the end faces of each fiber may be ground and/or polished into a flat surface without angle. Accordingly, an end face of each of the fibers may be ground and polished into a flat surface without angle.

The grooved spacer may include one side that provides a polished surface and an opposite side with M, N, or M×N microgrooves. The position of each microgroove may correspond to the position of a respective fiber in the M×N array of fibers. Moreover, the width of each microgroove may be greater than the light output area of its respective fiber(s). The microlens array (MLA) may include an M×N array of microlenses. The position of each microlens may correspond to the position of a respective fiber in the two-dimensional (2D) fiber array. The two-dimensional (2D) fiber array, the grooved spacer, and the microlens array (MLA) may be assembled using an adhesive having a refractive index that substantially matches the refractive index of the fiber core.

In various embodiments, the microgrooves may not only eliminate the F-P (Fabry-Perot) etalon effect between end faces of the fibers and the grooved spacer, but may also reduce the coupling efficiency of the reflected light from incident surfaces of each microgroove to its respective fiber. As such, the two-dimensional (2D) fiber collimator array may achieve a return loss (RL) of 50 dB or more.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

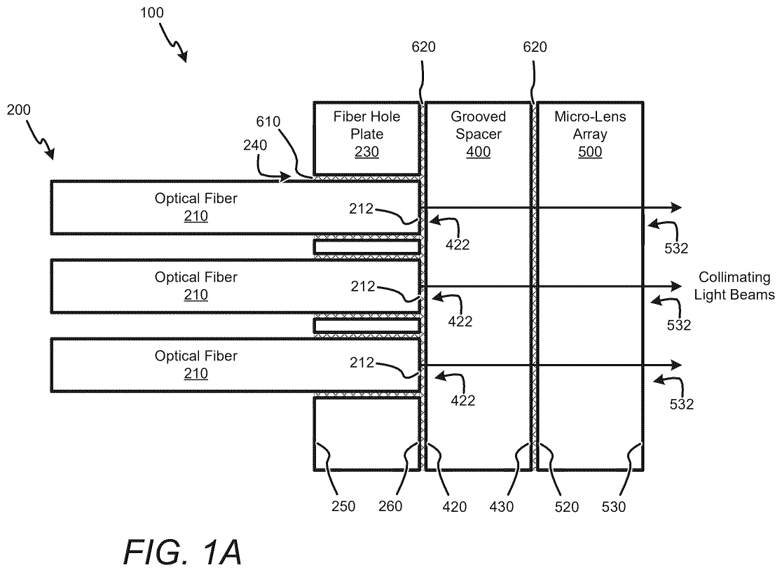

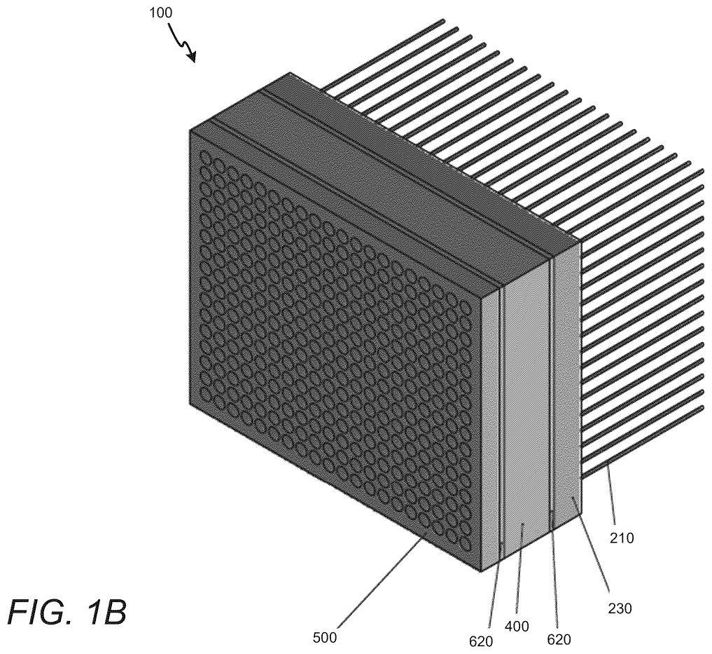

FIGS. 1A and 1B present a block diagram and perspective view of a two-dimensional (2D) fiber collimator array 100 in accordance with aspects of the present disclosure. The two-dimensional (2D) fiber collimator array 100 may include a two-dimensional (2D) fiber array 200, a grooved spacer 400, and a microlens array (MLA) 500.

The two-dimensional (2D) fiber array 200 may include an M×N array of single-mode optical fibers 210 (where M≥2, N≥2) and a fiber hole plate 230. Each fiber 210 may include a fiber end face 212. Moreover, the fiber hole plate 230 may include an M×N array of fiber holes 240 that extend through the fiber hole plate 230 from a fiber hole plate first side 250 to a fiber hole plate second side 260 opposite the fiber hole plate first side 250. Each fiber end face 212 may be inserted into a respective fiber hole 240 in the fiber hole plate first side 250 and threaded through its respective fiber hole 240 such that the fiber end face 212 is at or beyond the fiber hole plate second side 260. Further, a fiber hole plate adhesive 610 may affix each fiber 210 in its respective fiber hole 240 of the fiber hole plate 230. The fiber end faces 212 and the fiber hole plate second side 260 may be ground and/or polished to obtain a flat, planar surface. In particular, such polishing may result in fiber end faces 212 that are coplanar with the fiber hole plate second side 260. In this manner, the fiber hole plate 230 may arrange and present the fiber end faces 212 in an M×N array at the fiber hole plate second side 260.

The grooved spacer 400 may include a grooved spacer first side 420 and a grooved spacer second side 430 opposite the grooved spacer first side 420. Moreover, the grooved spacer 400 may be manufactured from a glass, crystal, and/or other materials, which have a high internal transmittance (e.g., greater than 99.5% per millimeter (mm) thickness and more preferably greater than 99.8% per millimeter (mm) thickness) for the optical signals to be transmitted. The grooved spacer first side 420 may include microgrooves 422 and may be bonded or otherwise coupled to the fiber hole plate second side 260 with an index-matching adhesive 620. The grooved spacer second side 430 may comprise a planar, polished surface opposite the grooved spacer first side 420. The microgrooves 422 may include (i) M microgrooves 422, wherein each microgroove 422 spans N fiber end faces 212; (ii) N microgrooves 422, wherein each microgroove 422 spans M fiber end faces 212; (iii) M×N microgrooves 422, wherein each microgroove 422 is aligned with a respective fiber end face 212, and/or (iv) some other arrangement, wherein the microgrooves 422 collectively span the M×N array of fiber end faces 212.

The grooved spacer 400 may include microgrooves 422 of various shapes including, but not limited to, wedge-shaped grooves, V-shaped grooves, W-shaped grooves, U-shaped grooves, arc-shaped grooves, etc. An incident surface 424 of each microgrooves 422 may have a very small roughness (e.g., less than 20 nanometers (nm) root mean square (RMS) from a mean line) to ensure that the incident light is not scattered as the incident light passes through the incident surface 424. The angle between the incident surface 424 of each microgroove 422 and the plane of the grooved spacer first side 420 is preferably greater than 4°and typically between 4° and 12°. Further, each microgroove 422 may provide a reception area that is greater than the light output area of its respective fiber end face(s) 212.

The microlens array (MLA) 500 may include a microlens array (MLA) first side 520 and a microlens array (MLA) second side 530 opposite the MLA first side 520. The MLA first side 520 may be affixed to the grooved spacer second side 430 via an index-matching adhesive 620. The MLA second side 530 may comprise an M×N array of microlenses 532. Each microlens 532 may be positioned such that it aligns with a respective fiber end face 212. In particular, the microlenses 532 may be positioned such that there is one-to-one correspondence between the position of each microlens 532 and the position of each fiber end face 212. The microlens array (MLA) 500 may be formed from glass, crystal, silicon, and/or other materials, which have a high internal transmittance (e.g., greater than 99.5% per millimeter (mm) thickness and more preferably greater than 99.8% per millimeter (mm) thickness) to the optical signal to be transmitted.

The fiber hole plate adhesive 610 may affix the fibers 210 in respective fiber holes 240 of the fiber hole plate 230. The index-matching adhesive 620 may affix the grooved spacer first side 420 to the fiber hole plate second side 260 and may affix the MLA first side 520 to the grooved spacer second side 430. In various embodiments, the index-matching adhesive 620 may have a refractive index that substantially matches the refractive index of the fiber core of the fibers 210. For example, the refractive index difference between the index-matching adhesive 620 and the fiber core may be less than ±0.01 or may be less than ±0.7%. Further, the index-matching adhesive 620 may have a high internal transmittance (e.g., greater than 95% per 0.1 millimeter (mm) thickness and more preferably greater than 98% per 0.1 millimeter (mm) thickness) for the optical signals to be transmitted.

In various embodiments, the microgrooves 422 may reduce and/or effectively eliminate the Fabry-Perot (F-P) etalon effect between the fiber end faces 212 and the grooved spacer 400. Moreover, the microgrooves 422 may also reduce the coupling efficiency of the reflected light from the surface of each microgroove 422 to its respective fiber end face 212. As such, the two-dimensional (2D) fiber collimator array 100 in various embodiments may achieve a return loss (RL) of 50 dB or more.

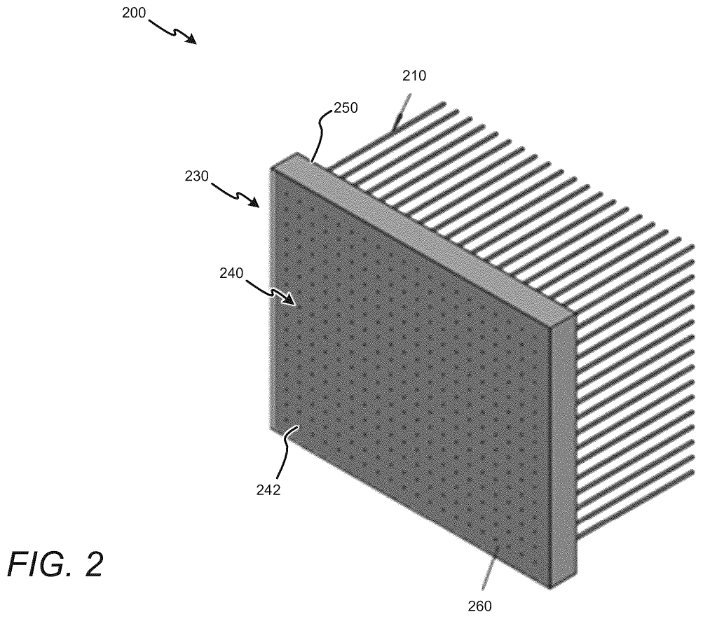

Referring now to FIG. 2, a perspective view of an example two-dimensional (2D) fiber array 200 is shown. The two-dimensional (2D) fiber array 200 may include three hundred twenty (20×16=320) single-mode optical fibers 210, which collectively provide three hundred twenty (320) optical channels. More specifically, the two-dimensional (2D) fiber array 200 may arrange the fibers 210 in sixteen (16) rows and twenty (20) columns, such that each row includes twenty (20) fibers 210 and each column includes sixteen (16) fibers 210. In the depicted embodiment, the vertical spacing or pitch between rows may be uniform, the horizontal spacing or pitch between columns may be uniform, and the vertical spacing and the horizontal spacing may be same (e.g., vertical spacing between each row of 1.5 millimeters (mm), and horizontal spacing between columns of 1.5 mm). However, other embodiments may arrange fiber holes 240 such that the vertical spacing between rows differs from the horizontal spacing between columns, the vertical spacing between rows is non-uniform, and/or the horizontal spacing between columns is non-uniform.

FIG. 2 further depicts three hundred twenty (320) fibers 210 affixed in three hundred twenty (320) fiber holes 240 of the fiber hole plate 230. The fiber hole plate 230 may be manufactured from glass, silicon, or other materials, which are suitable to photolithography and etching processes. In various embodiments, the fiber holes 240 may be formed via a photolithography and etching process with sub-micron dimensional accuracy and with a pitch error between fiber holes 240 of 1.0 micron (μm) or less. As further shown, the fiber end faces 212 of the three hundred twenty (320) fibers 210 and/or the fiber hole plate second side 260 may be ground and/or polished into a flat surface such that each fiber end face 212 is coplanar with the fiber hole plate second side 260 and without angles.

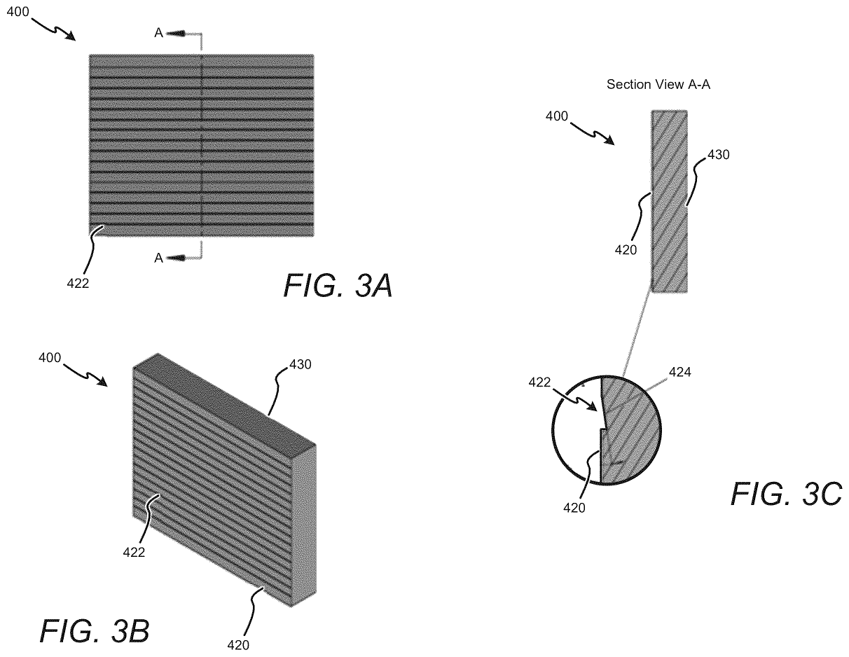

Referring now to FIG. 3A-3C, an example grooved spacer 400 is depicted. The grooved spacer 400 may be formed from a glass, crystal, and/or other materials, which have a high internal transmittance (e.g., greater than 99.5% per millimeter (mm) thickness and more preferably greater than 99.8% per millimeter (mm) thickness) to the optical signals to be transmitted. The grooved spacer second side 430 may be a polished plane, whereas the grooved spacer first side 420 may include sixteen (16) microgrooves. Each microgroove 422 may extend horizontally across the grooved spacer first side 420 and span sixteen (16) fiber end faces 212 in a row of fiber holes 240. Further, each microgroove 422 may be wedge-shaped so as to present its associated fiber end faces 212 with an incident surface 424 having an angle of 8° with respect to the plane of the grooved spacer first side 420.

As shown in FIG. 3C, the incident surface 424 of each microgroove 422 may be angled in the vertical direction. As such, the incident surface 424 spans a distance vertically across a fiber end face 212 in a row, thus only marginally reducing the overall thickness of the grooved spacer 400 between grooved spacer first side 420 and the grooved spacer second side 430. Moreover, the angle of the incident surface 424 may be adjusted to achieve a high return loss (RL). Preferably, the angle of the incident surface 424 is greater than 4°, and more preferably between 4° and 12°. In various embodiments, the width of each microgroove 422 in the vertical direction may be greater than 10μm, and more preferably between 20μm and 300μm. To achieve a high return loss (RL), the vertical spacing between the microgrooves 422 may substantially match the vertical spacing of between the rows of fiber end faces 212. For example, in one embodiment, the vertical spacing between the microgrooves 422 and the vertical spacing between the rows of fiber end faces 212 may be 1.5 mm.

When assembling, the center of each microgroove 422 may be vertically aligned with the center of the fiber core of each fiber end face 212 such that a center line passing horizontally through each microgroove 422 aligns with a center line passing horizontally through a corresponding row of fiber end faces 212. The microgrooves 422 may be formed by photolithography and etching a glass substrate, a diamond turning processing, molding process, etc. Furthermore, the microgrooves 422 may be manufactured to provide an incident surface 424 having a small roughness. For example, the incident surface 424 may be manufactured to have a surface roughness of less than a 20 nanometers (nm) root mean square (RMS) average deviation from a mean line. Such a small surface roughness may effectively prevent or reduce scattering of light passing through the incident surface 424 of the microgroove 422.

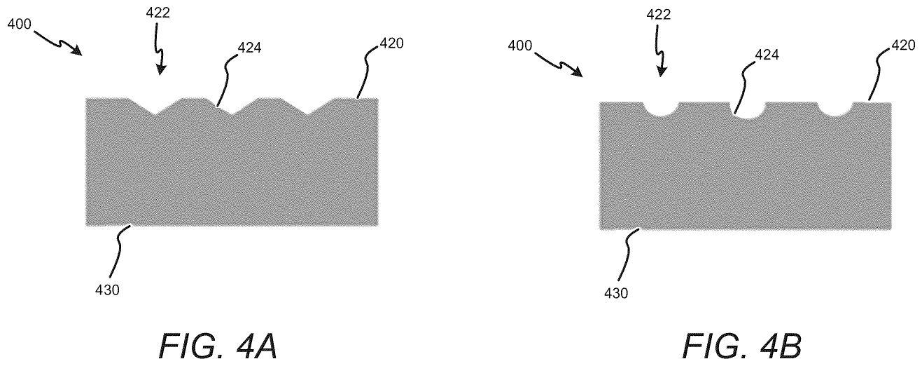

While the microgrooves 422 may be wedge-shaped as shown in FIG. 3C, the grooved spacer 400 may be implemented with microgrooves 422 having other shapes. For example, the microgrooves 422 may have a V-shape as shown in FIG. 4A or a U-shape/arc-shape as shown in FIG. 4B. The incident surface(s) 424 provided by microgrooves 422 may reduce or effectively eliminate the F-P etalon effect between the fiber end faces 212 and the grooved spacer 400. Further, the incident surface(s) 424 provided by the microgrooves 422 may reduce or effectively eliminate the coupling efficiency of light reflected from the grooved spacer 400 into the fiber end faces 212, thus increasing the return loss (RL).

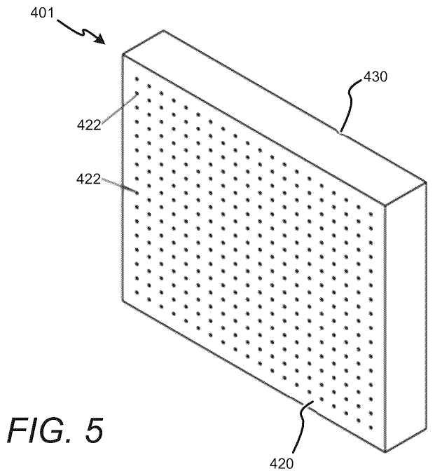

Another embodiment of the grooved spacer 401 is shown in FIG. 5. As explained above, the groove spacer 400 of FIG. 3A-3C may include a separate microgroove 422 for each row of fiber end faces 212 in the two-dimensional (2D) fiber array 200. Thus, for the depicted 16×20 two-dimensional (2D) fiber array 200, the groove spacer 400 may include a total of sixteen (16) microgrooves 422, one microgroove 422 for each of the sixteen (16) rows of fiber end faces 212. The grooved spacer 401 of FIG. 5, however, may include a separate microgroove 422 for each fiber end face 212 in the two-dimensional (2D) fiber array 200. Thus, for the depicted 16×20 two-dimensional (2D) fiber array 200, the groove spacer 401 may include a total of three hundred twenty (320) microgrooves 422, one microgroove 422 for each of the three hundred twenty (320) fiber end faces 212 in the two-dimensional (2D) fiber array 200.

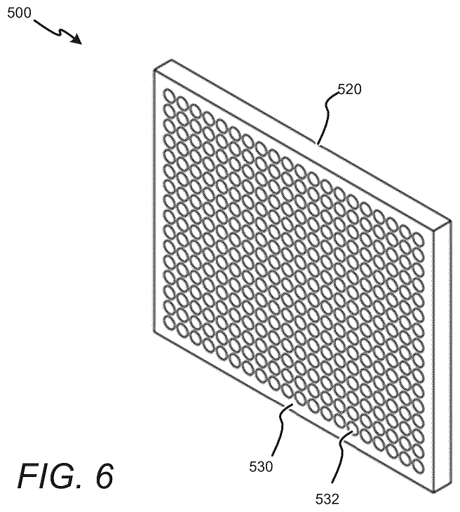

As shown in FIG. 6, the microlens array (MLA) 500 may include a microlens 532 for each fiber end face 212. In particular, for the 20×16 two-dimensional (2D) fiber array 200 of FIG. 2, the microlens array (MLA) 500 may include three hundred twenty (320) microlenses 532, one for each of the three hundred twenty (320) fiber end faces 212. Moreover, the vertical spacing and horizontal spacing between the microlenses 532 may substantially match the vertical spacing and horizontal spacing between fiber end faces 212.

In various embodiments, the microlens array (MLA) 500 may comprise glass, crystal, or other materials, which have a high internal transmittance (e.g., greater than 99.5% per millimeter (mm) thickness and more preferably greater than 99.8% per millimeter (mm) thickness) for the optical signals to be transmitted. Moreover, the microlens array (MLA) 500 may be formed from such materials using a photolithography and etching process or a molding process. Such processes may achieve a very high accuracy pitch (e.g., pitch tolerance less than 1 μm) between microlens 532 of the microlens array. In order to reduce insertion loss, the MLA first side 520 and/or the grooved spacer second side 430 may be coated with an anti-reflection (AR) coating with respect to the index-matching adhesive 620. Similarly, the MLA second side 530 and associated convex surfaces of the microlenses 532 may be coated with an anti-reflection (AR) coating respect to air.

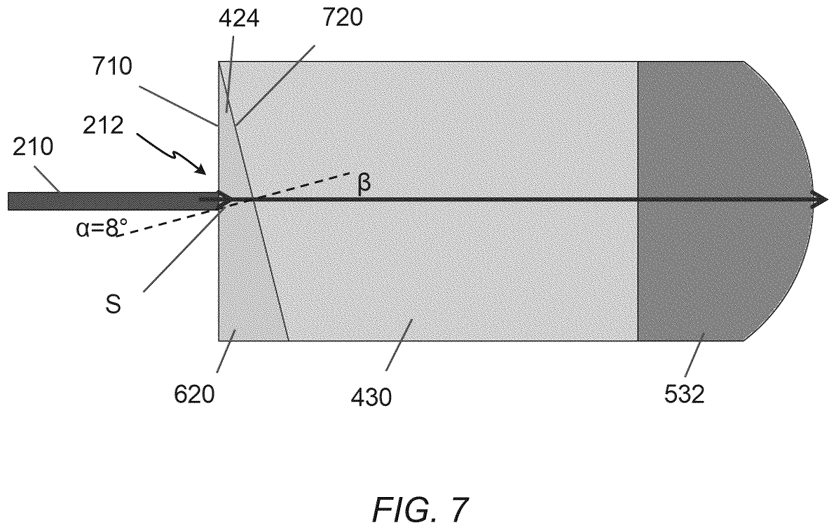

Referring now to FIG. 7, a schematic diagram of an optical transmission path for light emitted from a single fiber 210 is shown. In one embodiment, the optical signal output S from each single-mode fiber 210 has wavelength between 1260 nanometers (nm) and 1610 nm. As shown, the output optical signal S is emitted from the fiber end face 212 incident to a first interface 710 between the fiber end face 212 and a first side of the index-matching adhesive 620. The output optical signal S passes through the index-matching adhesive 620 to a second interface 720 between a second side of the index-matching adhesive 620 and the incident surface 424 of a respective microgroove 422.

As shown, the index-matching adhesive 620 fills the area between the first interface 710 and the second interface 720. The incident angle of the output optical signal S on the first interface 710 is close to 0°. However, the incident surface 424 of the microgroove 422 is angled with respect to first interface 710 by an angle α (e.g., 8°). As a result of the angle α, an F-P cavity is not formed, and the F-P etalon effect is reduced and/or eliminated. At the same time, the optical output signal S incident on the second interface 720 is reflected by the incident surface 424 by a reflection angle 2α (e.g., 16°), which exceeds the numerical aperture (NA) value (e.g. 0.14) of the fiber end face 212. As such, the reflected signal does not recouple into the single-mode fiber 210, thus resulting in a recoupling efficiency close to zero. As such, effectively only the reflected light at first interface 710 affects the return loss (RL).

Due to the index-matching adhesive 620 having a refractive index close to the refractive index of the fiber core of the fiber 210 (e.g., less than ±0.01 difference or less than a ±0.7% difference), reflectivity at the first interface 710 may be reduced. In addition, due to the refractive indices of the fiber core of the fiber 210, the index-matching adhesive 620, and the grooved spacer 400 being substantially matched, the difference between the refractive angle β of the optical output signal and the incident angle α is very small in accordance with Snell's law. As such, the optical output signal S effectively passes straight through the first interface 710 and the second interface 720 although the incident surface 424 has the angle α. Such a straight optical path not only ensures the quality of the collimating beam, but also simplifies aligning the microlenses 532 with respective fiber end faces 212 as there is no need to account for change in optical path as the optical output signal S passes through the index-matching adhesive 620 and groove spacer 400.

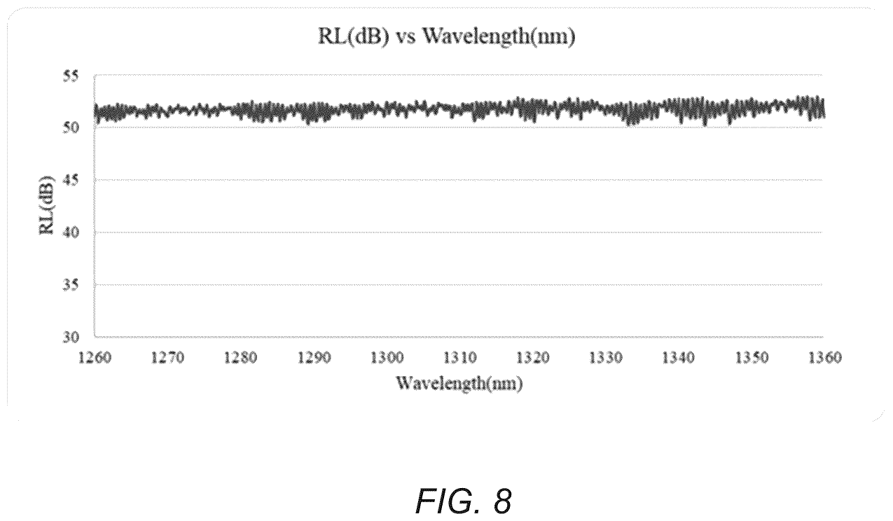

The microgrooves 422 may not only reduce or effectively eliminate the F-P etalon effect between the fiber end face 212 and the grooved spacer 400, but may also reduce the coupling efficiency of the reflected light from the incident surface 424 into the fiber end face 212. As such, the two-dimensional (2D) fiber collimator array 100 may achieve a high return loss (RL) specification. For example, FIG. 8 shows a measured return loss (RL) versus wavelength curve of a two-dimensional (2D) fiber collimator array 100 in accordance with the present disclosure. As can be seen, the two-dimensional (2D) fiber collimator array 100 may achieve a measured return loss (RL) value of greater than 50 dB across wavelengths from 1260 nm to 1360 nm.

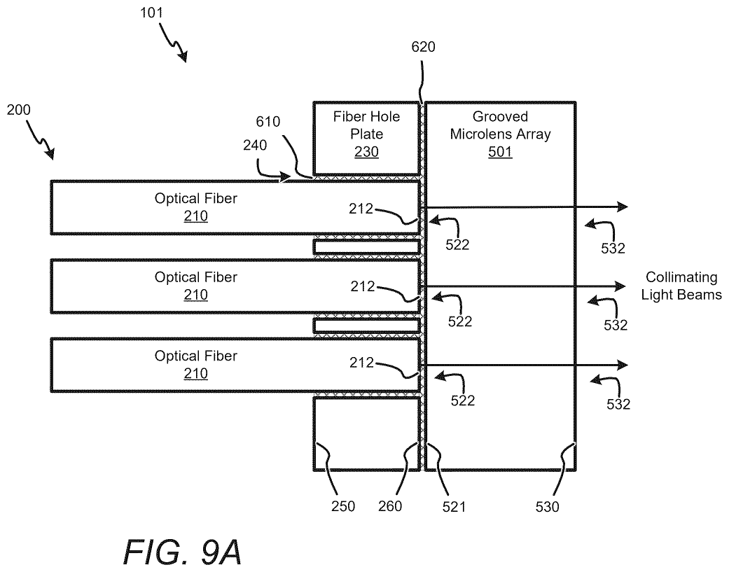

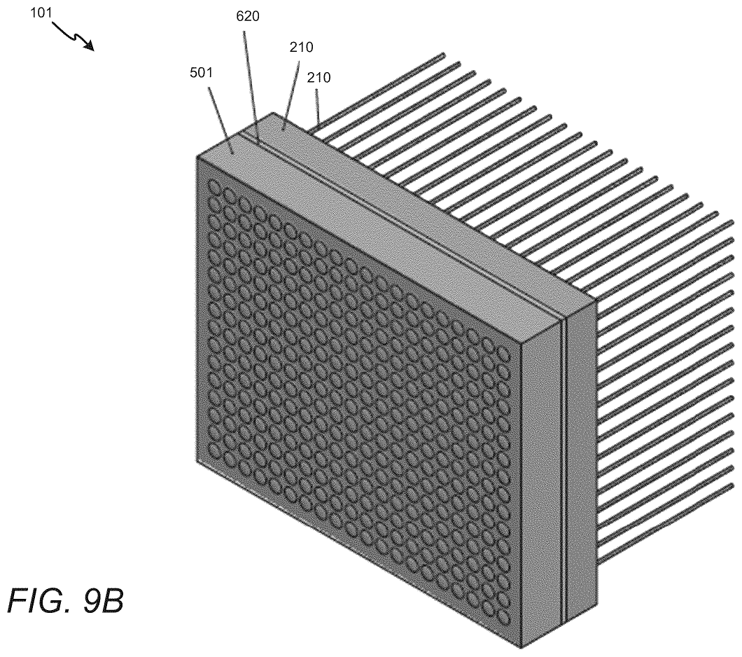

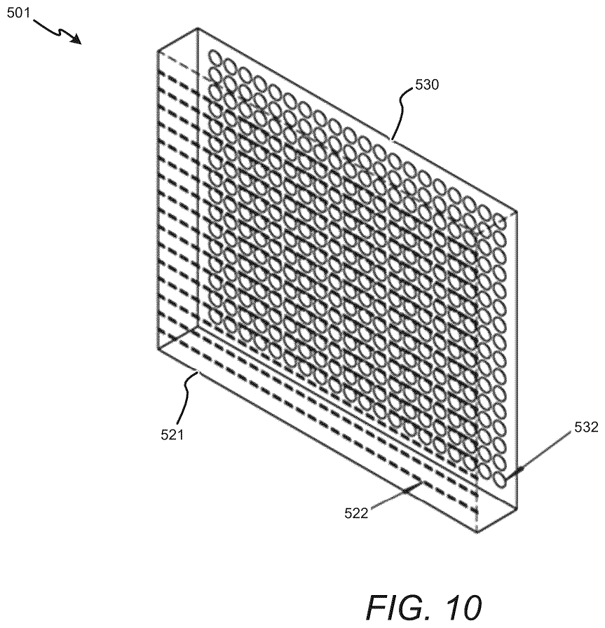

Referring now to FIGS. 9A, 9B, and 10, a second embodiment of a two-dimensional (2D) fiber collimator array 101 is shown. The two-dimensional (2D) fiber collimator array 101 of FIGS. 9A, 9B, and 10 may be implemented in a similar manner as the two-dimensional (2D) fiber collimator array 100 of FIGS. 1A and 1B. As noted above, the microlens array (MLA) 500 of the two-dimensional (2D) fiber collimator array 100 may be affixed to the grooved spacer 400 via index-matching adhesive 620. In contrast, the two-dimensional (2D) fiber collimator array 101 includes a grooved microlens array (MLA) 501 instead of a separate grooved spacer 400 and a microlens array (MLA) 500.

In particular, the grooved microlens array (MLA) 501 may include a grooved microlens array (MLA) first side 521 and a grooved MLA second side 530 opposite the grooved MLA first side 521. Similar to the microlens array (MLA) 500, the grooved microlens array (MLA) 501 may include microlenses 532 on its groove MLA second side 530. Such microlenses 532 of the grooved microlens array (MLA) 501 may be implemented in a manner similar to the microlenses 532 of the microlens array (MLA) 500.

However, unlike the microlens array (MLA) 500, the grooved MLA first side 521 may include microgrooves 522. In particular, the microgrooves 522 may be formed in the grooved MLA first side 521 in a manner similar to the microgrooves 422 of the grooved spacer 400. Similarly to the grooved spacer 400, the grooved MLA first side 521 may be coupled to the fiber hole plate second side 260 using index-matching adhesive 620. In this manner, the grooved microlens array (MLA) 501 may provide microgrooves 522 and microlenses 532 that align with fiber end faces 212. Such microgrooves 522 and index-matching adhesive 620 may reduce or effectively eliminate the F-P etalon effect between the fiber end face 212 and the grooved microlens array (MLA) 501. Moreover, such microgrooves 522 may also reduce the coupling efficiency of the reflected light from the incident surface of the microgrooves 522 into the fiber end face 212. As such, the two-dimensional (2D) fiber collimator array 101 may achieve a high return loss (RL) of greater than 50 db across wavelengths from 1260 nm to 1360 nm in a manner similar to the two-dimensional (2D) fiber collimator array 100.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A fiber collimator array, comprising:
a fiber hole plate comprising a fiber hole plate first side, a fiber hole plate second side opposite the fiber hole plate first side, and rows of holes, wherein each hole extends through the fiber hole plate from the fiber hole plate first side to the fiber hole plate second side;
a plurality of fibers, wherein each fiber extends through a respective hole of the fiber hole plate and comprises a fiber end face at the fiber hole plate second side;
a grooved spacer comprising a grooved spacer first side and a grooved spacer second side opposite the grooved spacer first side, wherein the grooved spacer first side comprises a plurality of microgrooves, and wherein each microgroove comprises an incident surface angled with respect to the grooved spacer first side; and
an adhesive that couples the grooved spacer first side to the fiber hole plate second side, wherein a refractive index of the adhesive substantially matches a refractive index of the fiber end faces.

2. The fiber collimator array of claim 1, wherein the refractive index of the adhesive and the refractive index of the fiber end faces differ by less than ±0.01.

3. The fiber collimator array of claim 1, wherein the refractive index of the adhesive and the refractive index of the fiber end faces differ by less than ±0.7%.

4. The fiber collimator array of claim 1, wherein each microgroove is wedge-shaped, U-shaped, or V-shaped.

5. The fiber collimator array of claim 1, wherein the incident surface of each microgroove is angled more than 4° from the grooved spacer first side.

6. The fiber collimator array of claim 1, wherein the incident surface of each microgroove is angled between 4° and 12° from the grooved spacer first side.

7. The fiber collimator array of claim 1, wherein the plurality of microgrooves includes a separate microgroove for each row of holes.

8. The fiber collimator array of claim 7, wherein the incident surface of each microgroove is vertically angled into the grooved spacer first side.

9. The fiber collimator array of claim 1, wherein the plurality of microgrooves includes a separate microgroove for each hole of the rows of holes.

10. The fiber collimator array of claim 1, comprising:
a microlens array comprising a microlens array first side and a microlens array second side opposite the microlens array first side;
wherein the microlens array first side is coupled to the grooved spacer second side; and
wherein the microlens array second side comprises a plurality of microlenses.

11. A fiber collimator array, comprising:
a fiber hole plate comprising a fiber hole plate first side, a fiber hole plate second side opposite the fiber hole plate first side, and rows of holes, wherein each hole extends through the fiber hole plate from the fiber hole plate first side to the fiber hole plate second side;
a plurality of fibers, wherein each fiber extends through a respective hole of the fiber hole plate and comprises a fiber end face at the fiber hole plate second side;
a grooved microlens array comprising a grooved microlens array first side and a groove microlens array second side opposite the grooved microlens array first side, wherein the grooved microlens array first side comprises a plurality of microgrooves, wherein the grooved microlens array second side comprises a plurality of microlenses, and wherein each microgroove comprises an incident surface angled with respect to the grooved microlens array first side; and
an adhesive that couples the grooved microlens array first side to the fiber hole plate second side, wherein a refractive index of the adhesive substantially matches a refractive index of the fiber end faces.

12. The fiber collimator array of claim 11, wherein the refractive index of the adhesive and the refractive index of the fiber end faces differ by less than ±0.01.

13. The fiber collimator array of claim 11, wherein the refractive index of the adhesive and the refractive index of the fiber end faces differ by less than ±0.7%.

14. The fiber collimator array of claim 11, wherein the adhesive fills each microgroove.

15. The fiber collimator array of claim 11, wherein each microgroove is wedge-shaped, U-shaped, or V-shaped.

16. The fiber collimator array of claim 11, wherein the incident surface of each microgroove is angled more than 4° from the grooved microlens array first side.

17. The fiber collimator array of claim 11, wherein the incident surface of each microgroove is angled between 4° and 12° from the grooved microlens array first side.

18. The fiber collimator array of claim 11, wherein the plurality of microgrooves includes a separate microgroove for each row of holes.

19. The fiber collimator array of claim 18, wherein the incident surface of each microgroove is vertically angled into the grooved microlens array first side.

20. The fiber collimator array of claim 11, wherein the plurality of microgrooves includes a separate microgroove for each hole of the rows of holes.
